(19) United States
(12) Patent Application Publication
(10) Pub. No.: US 2023/0026138 A1
(43) Pub. Date: Jan. 26, 2023

(54) VEHICLE INFORMATION MANAGEMENT SYSTEM

(71) Applicant: TOYOTA JIDOSHA KABUSHIKI KAISHA, Aichi-ken (JP)

(72) Inventors: Masato ENDO, Nagoya-shi (JP); Yasuyuki KAMEZAKI, Toyota-shi (JP); Yasuhiro MURATA, Toyota-shi (JP); Takeo MORIAI, Nagakute-shi (JP); Kosuke SAKAKIBARA, Toyota-shi (JP); Kenta MIYAHARA, Okazaki-shi (JP); Takashi HAYASHI, Nagoya-shi (JP)

(21) Appl. No.: 17/830,340

(22) Filed: Jun. 2, 2022

(30) Foreign Application Priority Data
Jul. 26, 2021 (JP) 2021-122032

(51) Int. Cl. G06Q 30/02; G06Q 10/00

(52) U.S. Cl. CPC G06Q 30/0278; G06Q 10/20

(57) ABSTRACT

In a vehicle information management system, a maintenance information determination unit determines whether maintenance of a vehicle was carried out at a predetermined maintenance shop based on maintenance history information acquired by a maintenance history information database, and when the maintenance information determination unit determines that the maintenance of the vehicle was carried out at the predetermined maintenance shop, an added value information providing unit provides added value information to appraisal information of the vehicle.

### CROSS-REFERENCE TO RELATED APPLICATION

This application claims priority to Japanese Patent Application No. 2021-122032 filed on Jul. 26, 2021, incorporated herein by reference in its entirety.

### BACKGROUND

### 1. Technical Field

The present disclosure relates to a vehicle information management system.

### 2. Description of Related Art

Japanese Unexamined Patent Application Publication No. 2002-366829 (JP 2002-366829 A) discloses a disclosure relating to a vehicle information providing system. In the vehicle information providing system, traveling data obtained by an in-vehicle device of the vehicle is collected, and driving condition data corresponding to the driving condition of the previous owner is determined. The vehicle information providing system obtains comprehensive value data indicating a comprehensive value of the vehicle as a used vehicle based on internal value data determined based on the driving condition data and external value data determined based on the specifications and the like of the vehicle, and provides the comprehensive value data to users via the Internet and the like.

### SUMMARY

Examples of the data for determining the value of a used vehicle include vehicle maintenance data, in addition to the above-mentioned data. Specifically, from the perspective of the seller who sells used vehicles to users, a used vehicle maintained at a specific maintenance shop with high technical capabilities has a higher value than a used vehicle maintained at the other maintenance shops because the probability of problems occurring in the future is lower.

On the other hand, from the perspective of vehicle owners, the added value of the vehicle can be improved when the vehicle is maintained at a specific maintenance shop with high technical capabilities, which motivates the vehicle owners to have the vehicle maintained at a specific maintenance shop with high technical capabilities, That is, by providing an added value to used vehicles based on the vehicle maintenance data, it is possible to increase the probability that high-quality used vehicles will be distributed in the market.

In consideration of the above facts, an object of the present disclosure is to obtain a vehicle information management system capable of increasing the probability that high-quality used vehicles will be distributed in the market.

A vehicle information management system according to the present disclosure of claim 1 includes: an appraisal information generation unit that generates appraisal information of a vehicle based on vehicle condition information based on a condition of the vehicle; an acquisition unit configured to acquire maintenance history information of the vehicle; a determination unit configured to determine whether maintenance of the vehicle was carried out at a predetermined maintenance shop based on the maintenance history information acquired by the acquisition unit; and an added value information providing unit that provides added value information to the appraisal information when the determination unit determines that the maintenance of the vehicle was carried out at the predetermined maintenance shop.

According to the present disclosure of claim 1, the appraisal information generation unit generates the appraisal information of the vehicle based on the vehicle condition information based on the condition of the vehicle. In addition, the acquisition unit acquires the vehicle maintenance history information.

The determination unit determines whether the maintenance of the vehicle was carried out at the predetermined maintenance shop based on the maintenance history information acquired by the acquisition unit, and when the determination unit determines that the maintenance of the vehicle was carried out at the predetermined maintenance shop, the added value information providing unit provides the added value information to the appraisal information of the vehicle.

Thus, from the perspective of a seller who sells a used vehicle to a user, it is possible to purchase the used vehicle using the added value information of the vehicle as a guideline. On the other hand, from the perspective of the owner of the vehicle, it is possible to improve the added value of the vehicle by having the vehicle maintained at the predetermined maintenance shop.

The vehicle information management system according to the present disclosure of claim 2 further includes, in the disclosure of claim 1, a transmission unit configured to transmit the added value information.

According to the present disclosure of claim 2, the transmission unit can transmit the added value information of the vehicle to, for example, an external server and the like, and share the added value information at facilities and the like that can communicate with the external server.

The vehicle information management system according to the present disclosure of claim 3 further includes, in the disclosure of claim 1 or 2, a vehicle appraisal amount determination unit that assesses an appraisal amount of the vehicle based on the appraisal information and the added value information.

According to the present disclosure of claim 3, the vehicle appraisal amount determination unit assesses the appraisal amount of the vehicle based on the appraisal information of the vehicle and the added value information. Therefore, the added value information can be incorporated in the appraisal amount of the vehicle.

In the vehicle information management system according to the present disclosure of claim 4, in the disclosure of any one of claims 1 to 3, the added value information providing unit is configured to acquire a maintenance frequency of the vehicle from the maintenance history information and adjust the added value information based on the maintenance frequency; and the added value information providing unit increases an added value by the added value information as the maintenance frequency increases.

According to the present disclosure of claim 4, the added value information providing unit acquires the maintenance frequency of the vehicle from the maintenance history information, and adjusts the added value information based on the maintenance frequency. The added value information providing unit increases the added value by the added value information as the maintenance frequency of the vehicle increases. Therefore, in the present disclosure, it is possible to encourage the owner of the vehicle to increase the frequency of maintenance of the vehicle.

In the vehicle information management system according to the present disclosure of claim 5, in the disclosure of any one of claims 1 to 4, the determination unit compares the vehicle condition information with the maintenance history information, and when there is information, in the vehicle condition information, that does not match the maintenance history information, the determination unit determines that the maintenance of the vehicle was carried out at a place other than the predetermined maintenance shop.

According to the present disclosure of claim 5, the determination unit compares the vehicle condition information with the maintenance history information, and when there is information, in the vehicle condition information, that does not match the maintenance history information, the determination unit determines that the maintenance of the vehicle was carried out at a place other than the predetermined maintenance shop. Thus, in the present disclosure, when the maintenance of the vehicle is carried out at a place other than the predetermined maintenance shop, the added value information is not provided to the appraisal information of the vehicle. As a result, it is possible to encourage the owner of the vehicle to have maintenance of the vehicle at the predetermined maintenance shop.

As described above, the vehicle information management system according to the present disclosure has an excellent effect of increasing the probability that high-quality used vehicles will be distributed in the market.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram schematically showing a configuration of a vehicle information management system according to the present embodiment;

FIG. 2 is a block diagram showing a hardware configuration of a data server that constitutes a part of the vehicle information management system according to the present embodiment;

FIG. 3 is a block diagram showing a functional configuration of the vehicle information management system according to the present embodiment; and

FIG. 4 is a flowchart showing an example of a flow of an added value information processing of a vehicle by the vehicle information management system according to the present embodiment.

### DETAILED DESCRIPTION OF EMBODIMENTS

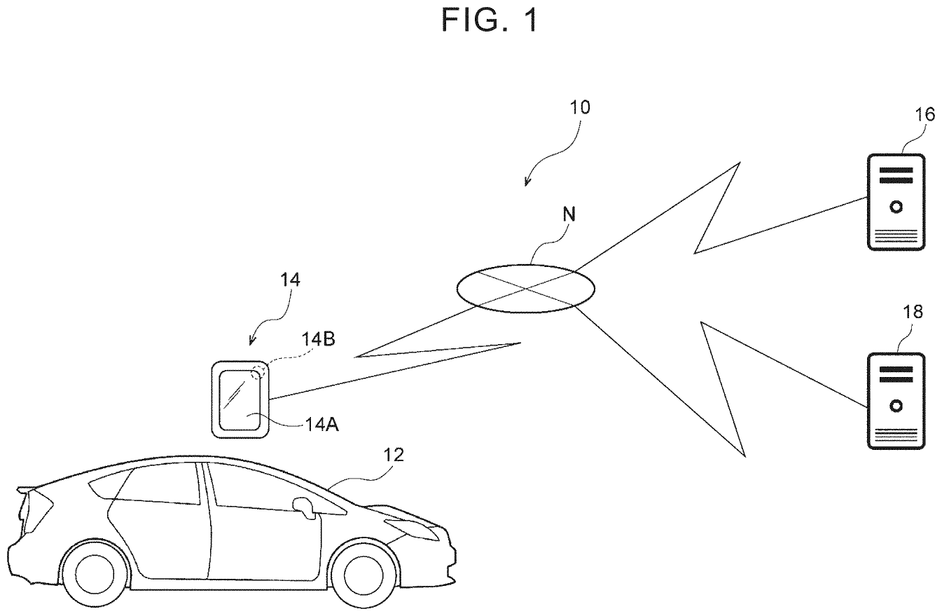

Hereinafter, an example of an embodiment of a “vehicle information management system 10” according to the present disclosure will be described with reference to FIGS. 1 to 4. As shown in FIG. 1, the vehicle information management system 10 includes a terminal 14 used by a worker of a predetermined maintenance shop that carries out maintenance of a “vehicle 12”, specifically, a maintenance shop owned or designated by a dealership, a data server 16, a web server 18, and a network N connecting the terminal 14, the data server 16, and the web server 18 so as to enable communication therebetween.

The terminal 14 is a mobile terminal provided with a display 14A capable of displaying various information and a camera 14B, for example, and various devices such as smartphones and tablets can be adopted as the terminal 14. The terminal 14 can communicate with the data server 16 and the like via the network N.

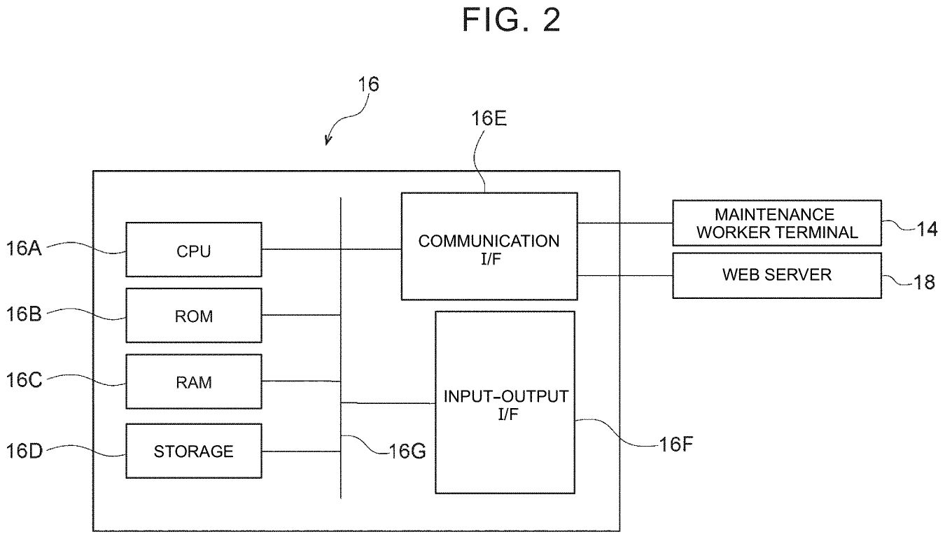

As shown in FIG. 2, the data server 16 includes a central processing unit (CPU) 16A, a read-only memory (ROM) 16B, a random access memory (RAM) 16C, a storage 16D, a communication interface (I/F) 16E serving as a transmission unit, and an input-output I/F 16F. The CPU 16A, the ROM 16B, the RAM 16C, the storage 16D, the communication O/F 16E, and the input-output i/F 16F are connected so as to be able to communicate with each other via, a bus 16G.

The CPU 16A is a central arithmetic processing unit, and is capable of executing various programs related to information processing of the vehicle 12 maintained at a predetermined maintenance shop. Specifically, the CPU 16A is capable of reading the program from the ROM 16B and executing the program using the RAM 16C as a work area. The data server 16 can exert various functions that will be described later, as the execution program stored in the ROM 16B is read out and executed by the CPU 16A.

The storage 16D includes a hard disk drive (HDD) or a solid state drive (SSD), and stores various programs including an operating system and various types of data. Further, as will be described later, the storage 16D can store various information and the like of the vehicle 12.

The communication I/F 16E is an interface used for connecting the data server 16 and the network N. and the communication I/F 16E is capable of communicating with the terminal 14 and the like via the network N. For the interface, for example, communication standards such as Ethernet (registered trademark), fiber-distributed data interface (FDDI), and Wi-Fi (registered trademark) are used.

The input-output I/F 16F is an interface for the data server 16 to communicate with various devices such as a monitor connected to the data server 16.

In the present embodiment, the execution program related to an appraisal of the vehicle 12 and stored in the ROM 16B is read by the CPU 16A and executed, so that various appraisals of the vehicle 12 can be carried out based on various kinds of data related to the appraisal of the vehicle 12 and stored in the storage 16D and the like.

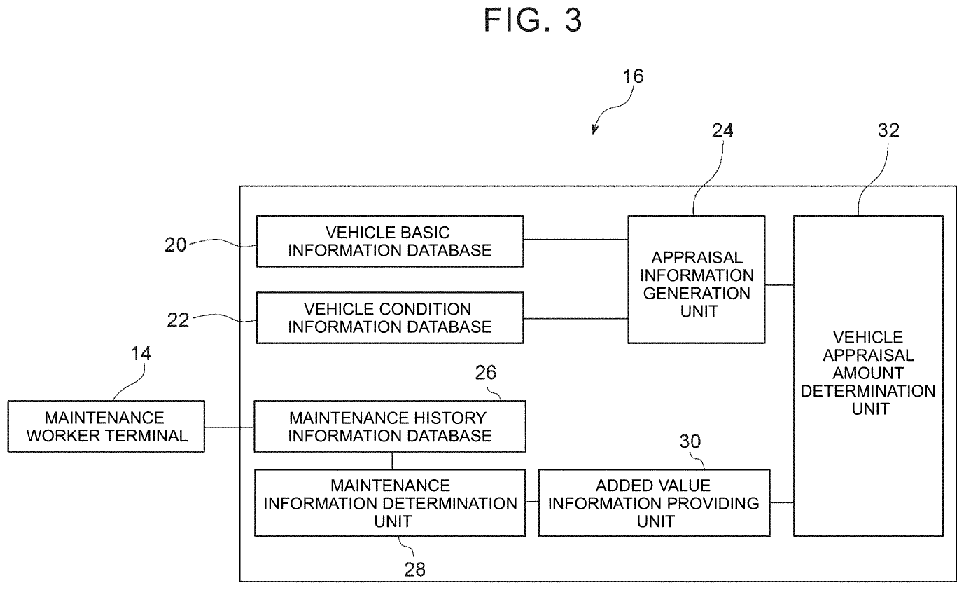

Specifically, as shown in FIG. 3, the data server 16 functions as a collection of a vehicle basic information database 20, a vehicle condition information database 22, an “appraisal information generation unit 24”, a “maintenance history information database 26” serving as an acquisition unit, a “maintenance information determination unit 28” serving as a determination unit, an “added value information providing unit 30”, and a “vehicle appraisal amount determination unit 32”.

The vehicle basic information database 20 is a database in which basic information of the vehicle 12 is stored. The vehicle basic information database 20 stores the vehicle basic information data table in which a vehicle identification (ID) assigned to the vehicle 12, a manufacturer, a model, a grade, a model year, and the like of the vehicle 12 are associated with each other.

The vehicle condition information database 22 is a database in which the condition information of the vehicle 12 is stored. The vehicle condition information database 22 stores a vehicle condition information data table in which the vehicle ID assigned to the vehicle 12, the traveling distance of the vehicle 12, image data of the exterior and the interior of the vehicle 12, and the like are associated with each other.

The appraisal information generation unit 24 evaluates the data stored in the vehicle basic information database 20 and the data stored in the vehicle condition information database 22 by, for example, artificial intelligence (AI), and generates the appraisal information of the vehicle 12. Examples of the appraisal information of the vehicle 12 include various kinds of information such as a quality evaluation score of the vehicle 12 rated on a five-point scale and a standard appraisal amount of the vehicle 12.

The maintenance history information database 26 acquires, via the network N, maintenance history information related to the maintenance operation of the vehicle 12 input to the terminal 14 by a worker of a predetermined maintenance shop, and can store the maintenance history information.

The maintenance history information database 26 stores the maintenance history information data table in which the vehicle ID assigned to the vehicle 12, the date of maintenance, content of work for the vehicle 12, the image data of a location of work that is taken by the camera 14B of the terminal 14, the ID of the worker, and the like are associated with each other. The content of work and the image data of the location of work for the vehicle 12 are also stored in the vehicle condition information database 22.

The maintenance information determination unit 28 compares the data of the vehicle 12 stored in the vehicle condition information database 22 with the data of the vehicle 12 stored in the maintenance history information database 26, and determines whether the maintenance of the vehicle 12 was carried out at a predetermined maintenance shop.

For example, the maintenance information determination unit 28 uses AI to compare the image data of the exterior of the vehicle 12 stored in the vehicle condition information database 22 with the image data of the location of work stored in the maintenance history information database 26, and when the data of the vehicle 12 stored in the vehicle condition information database 22 and the data of the vehicle 12 stored in the maintenance history information database 26 match, the maintenance information determination unit 28 determines that the maintenance of the vehicle 12 was carried out at the predetermined maintenance shop.

On the other hand, when there is information that does not match between the data of the vehicle 12 stored in the vehicle condition information database 22 and the data of the vehicle 12 stored in the maintenance history information database 26, the maintenance information determination unit 28 determines that the maintenance of the vehicle 12 was not carried out at the predetermined maintenance shop. The determination result by the maintenance information determination unit 28 is transmitted to the added value information providing unit 30.

When the maintenance information determination unit 28 determines that the maintenance of the vehicle 12 was carried out at the predetermined maintenance shop, the added value information providing unit 30 provides added value information to the appraisal information generated by the appraisal information generation unit 24. Examples of the added value information include predetermined points and an additional amount to the appraisal amount of the vehicle 12.

When the maintenance information determination unit 28 determines that the maintenance of the vehicle 12 was not carried out at the predetermined maintenance shop, the added value information providing unit 30 does not provide the added value information to the appraisal information generated by the appraisal information generation unit 24.

Further, the added value information providing unit 30 acquires the maintenance frequency of the vehicle 12 based on the maintenance history information acquired from the maintenance history information database 26, and adjusts the added value information based on the maintenance frequency.

Specifically, when the maintenance frequency of the vehicle 12 is equal to or higher than a predetermined frequency, the added value information providing unit 30 increases the value of the added value information, that is, increases the predetermined points or the additional amount to the appraisal amount of the vehicle 12, in accordance with the frequency. When the maintenance frequency of the vehicle 12 is lower than the predetermined frequency, the added value information providing unit 30 decreases the value of the added value information, that is, decreases the predetermined points or the additional amount to the appraisal amount of the vehicle 12, in accordance with the frequency.

Further, the added value information of the vehicle 12 set by the added value information providing unit 30 is transmitted to the web server 18 via the communication i/F 16E and uploaded from the web server 18 to the website operated by the dealership.

The vehicle appraisal amount determination unit 32 assesses an appraisal amount of the vehicle 12 based on the appraisal information of the vehicle 12 generated by the appraisal information generation unit 24 and the added value information of the vehicle 12 set by the added value information providing unit 30.

### Operations and Effects of Embodiment

Next, operations and effects of the present embodiment will be described.

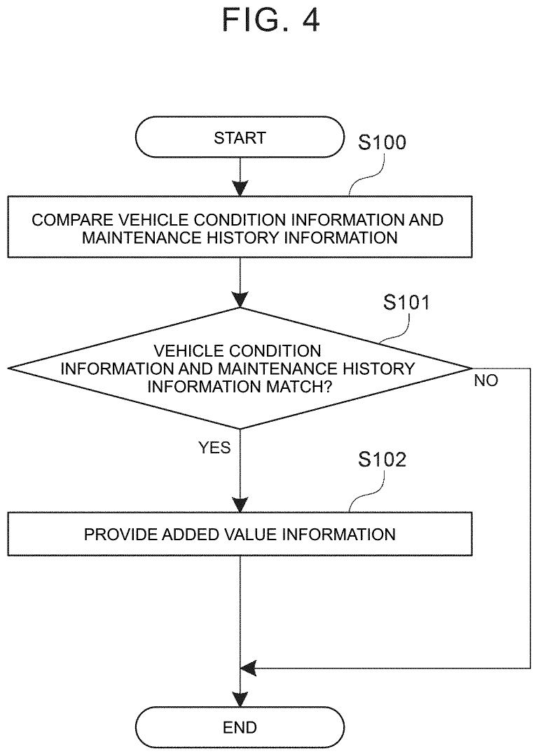

First, the added value information processing flow of the vehicle 12 by the program executed by the CPU 16A of the data server 16 will be described with reference to FIG. 4. The added value information processing flow is started when the CPU 16A receives a predetermined instruction signal.

When the added value information processing flow is started, the CPU 16A compares, in step S100 the data of the vehicle 12 stored in the vehicle condition information database 22 with the data of the vehicle 12 stored in the maintenance history information database 26. Then, the process proceeds to step S101.

In step S101, when the CPU 16A determines that the data of the vehicle 12 stored in the vehicle condition information database 22 and the data of the vehicle 12 stored in the maintenance history information database 26 match, that is, the CPU 16A determines that the maintenance of the vehicle 12 was carried out at the predetermined maintenance shop (step S101: YES), the process proceeds to step S102, When the CPU 16A determines that the data of the vehicle 12 stored in the vehicle condition information database 22 and the data of the vehicle 12 stored in the maintenance history information database 26 do not match that is, the CPU 16A determines that the maintenance of the vehicle 12 was not carried out at the predetermined maintenance shop (step S101: NO), the CPU 16A ends the control flow.

In step S102, the CPU 16A provides the added value information to the appraisal information of the vehicle 12, and ends the appraisal flow.

Further, in the present embodiment, as shown in FIG. 3, the appraisal information generation unit 24 generates the appraisal information of the vehicle 12 based on the vehicle condition information based on the condition of the vehicle 12. Further, the maintenance history information database 26 acquires the maintenance history information of the vehicle 12.

Then as described above, the maintenance information determination unit 28 determines whether the maintenance of the vehicle 12 was carried out at the predetermined maintenance shop based on the maintenance history information acquired by the maintenance history information database 26, and when the maintenance information determination unit 28 determines that the maintenance of the vehicle 12 was carried out at the predetermined maintenance shop, the added value information providing unit 30 provides the added value information to the appraisal information of the vehicle 12.

Thus, from the perspective of the seller who sells a used vehicle to a user, it is possible to purchase the used vehicle using the added value information of the vehicle 12 as a guideline. On the other hand, from the perspective of the owner of the vehicle 12, it is possible to improve the added value of the vehicle 12 by having the vehicle 12 maintained at the predetermined maintenance shop.

Further, according to the present embodiment, as shown in FIG. 2, the added value information of the vehicle 12 can be transmitted to the web server 18 through the communication I/F 16E of the data server 16 and shared at facilities and the like that can communicate with the web server 18.

Further, according to the present embodiment, the vehicle appraisal amount determination unit 32 assesses the appraisal amount of the vehicle 12 based on the appraisal information of the vehicle 12 and the added value information. Therefore, the added value information can be incorporated in the appraisal amount of the vehicle 12.

Further, according to the present embodiment, the added value information providing unit 30 acquires the maintenance frequency of the vehicle 12 from the maintenance history information, and adjusts the added value information based on the maintenance frequency. The added value information providing unit 30 increases the added value by the added value information as the maintenance frequency of the vehicle 12 increases. Therefore, in the present embodiment, it is possible to encourage the owner of the vehicle 12 to increase the frequency of maintenance of the vehicle 12.

In addition, according to the present embodiment, the maintenance information determination unit 28 compares the vehicle condition information with the maintenance history information, and when there is information, in the vehicle condition information, that does not match the maintenance history information, the maintenance information determination unit 28 determines that the maintenance of the vehicle 12 was carried out at a place other than the predetermined maintenance shop. Therefore, in the present embodiment, when the maintenance of the vehicle 12 is carried out at a place other than the predetermined maintenance shop, the added value information is not provided to the appraisal information of the vehicle 12. As a result, it is possible to encourage the owner of the vehicle 12 to have maintenance of the vehicle 12 at the predetermined maintenance shop.

As described above, in the present embodiment, it is possible to increase the probability that a high-quality used vehicle will be distributed in the market.

### Supplementary Description of Embodiment

(1) In the above-described embodiment, the maintenance history information input to the maintenance history information database 26 is input through the terminal 14, but the present disclosure is not limited to this. For example, equipment or devices capable of photographing the appearance of the vehicle may be installed in the predetermined maintenance shop, and the maintenance history information of the vehicle may be acquired using these.

(2) Further, in the above-described embodiment, the data server 16 is installed in each maintenance shop. However, various kinds of data related to the vehicles maintained at a plurality of maintenance shops may be processed by one data server depending on the number of vehicles and the like managed by the dealership.

(3) In addition, in the above-described embodiment, the added value information is provided to the appraisal information of the vehicle 12 when the data of the vehicle 12 stored in the vehicle condition information database 22 and the data of the vehicle 12 stored in the maintenance history information database 26 match, but the present disclosure is not limited to this. For example, when the data of the vehicle 12 stored in the vehicle condition information database 22 and the data of the vehicle 12 stored in the maintenance history information database 26 do not match but the maintenance history information database 26 of the vehicle 12 stores data including the ID of the worker of the predetermined maintenance shop, the added value information may be provided to the appraisal information of the vehicle 12.

What is claimed is:

1. A vehicle information management system comprising:
an appraisal information generation unit that generates appraisal information of a vehicle based on vehicle condition information based on a condition of the vehicle;
an acquisition unit configured to acquire maintenance history information of the vehicle;
a determination unit configured to determine whether maintenance of the vehicle was carried out at a predetermined maintenance shop based on the maintenance history information acquired by the acquisition unit; and
an added value information providing unit that provides added value information to the appraisal information when the determination unit determines that the maintenance of the vehicle was carried out at the predetermined maintenance shop.

2. The vehicle information management system according to claim 1, further comprising a transmission unit configured to transmit the added value information.

3. The vehicle information management system according to claim 1, further comprising a vehicle appraisal amount determination unit that assesses an appraisal amount of the vehicle based on the appraisal information and the added value information.

4. The vehicle information management system according to claim 1, wherein:
the added value information providing unit is configured to acquire a maintenance frequency of the vehicle from the maintenance history information and adjust the added value information based on the maintenance frequency; and
the added value information providing unit increases an added value by the added value information as the maintenance frequency increases.

5. The vehicle information management system according to claim 1, wherein the determination unit compares the vehicle condition information with the maintenance history information, and when there is information, in the vehicle condition information, that does not match the maintenance history information, the determination unit determines that the maintenance of the vehicle was carried out at a place other than the predetermined maintenance shop.
